(19) United States
(12) Patent Application Publication
(10) Pub. No.: US 2014/0324359 A1
(43) Pub. Date: Oct. 30, 2014

(54) PREDICTING THE MOLECULAR COMPLEXITY OF SEQUENCING LIBRARIES

(71) Applicants: Andrew D. Smith, Santa Monica, CA (US); Timothy P. Daley, Redondo Beach, CA (US)

(72) Inventors: Andrew D. Smith, Santa Monica, CA (US); Timothy P. Daley, Redondo Beach, CA (US)

(73) Assignee: UNIVERSITY OF SOUTHERN CALIFORNIA, Los Angeles, CA (US)

(21) Appl. No.: 14/262,356

(22) Filed: Apr. 25, 2014

Related U.S. Application Data
(60) Provisional application No. 61/816,038, filed on Apr. 25, 2013.

(51) Int. Cl. G06F 19/24

(52) U.S. Cl. CPC G06F 19/24
USPC 702/19

(57) ABSTRACT

Predicting the molecular complexity of a genomic sequencing library is a critical but difficult problem in modern sequencing applications. Methods to determine how deeply to sequence to achieve complete coverage or to predict the benefits of additional sequencing are lacking. We introduce an empirical Bayesian method to accurately characterize the molecular complexity of a DNA sample for almost any sequencing application based on limited preliminary sequencing.

### CROSS-REFERENCE TO RELATED APPLICATION

This application is based upon and claims priority to U.S. provisional patent application 61/816,038, filed Apr. 25, 2013, entitled “Numerical Method for Stable and Accurate Long-Range Predictions for the Yield of Distinct Classes from Random Sampling from an Unknown Number of Classes,” attorney docket no. 028080-0892, the entire content of which is incorporated herein by reference.

### STATEMENT REGARDING FEDERALLY SPONSORED RESEARCH

This invention was made with government support under Grant Nos. R01-HG005238 and P50-HG002790, awarded by the National Institutes of Health and National Health Genome Research Institute. The Government has certain rights in the invention.

### BACKGROUND

1. Technical Field

This disclosure relates to modern genomic sequencing applications.

2. Description of Related Art

Modern DNA sequencing experiments routinely interrogate hundreds of millions or even billions of reads, often to achieve deep coverage or to observe very rare molecules. Low complexity DNA sequencing libraries are problematic in such experiments: many sequenced reads will correspond to the same library molecules, and deeper sequencing will either provide redundant data or introduce biases in downstream analyses. When sequencing depth appears insufficient, investigators must decide whether to sequence more deeply from an existing library or to generate another. If this situation is anticipated during experimental design, investigators can plan to select from several libraries or samples for deep sequencing based on preliminary “shallow” surveys. The underlying question is how much new information will be gained from additional sequencing? The Lander-Waterman model (see Lander, E. & Waterman, M. Genomics, Vol. 2, pages 231-239 (1988)) was essential to understanding traditional Sanger sequencing experiments but does not account for the various biases typical in applications of high-throughput sequencing.

Predicting the molecular complexity of a genomic sequencing library is a critical but difficult problem in modern sequencing applications. Methods to determine how deeply to sequence to achieve complete coverage or to predict the benefits of additional sequencing are lacking. Common models are a simple Poisson model (i.e., Lander-Waterman model for genome sequencing), or variants, including the Negative Binomial model. The empirical Bayes model is also used, but has little practicality since the estimates are not stable for large extrapolations (see Efron & Thisted, Biometrika, Vol. 73, pages 435-447 (1976).

In the process of library preparation, the original DNA molecules are fragmented and then exponentially amplified by PCR to obtain enough genomic material for sequencing. The PCR amplification implies that there are a lot of copies of each molecule (and I mean a lot). The fragments are then sequenced and mapped.

### DESCRIPTION

### Summary

A statistical method and software provides accurate predictions of sequencing library complexity based on initial shallow sequencing surveys, enabling robust estimates of how deep to sequence for adequate coverage.

An empirical Bayesian method to accurately characterize the molecular complexity of a DNA sample for almost any sequencing application on the basis of limited preliminary sequencing.

Information gained from a sample of individual instances may be used to extrapolate the number of new, distinct instances that will be gained from continuing the experiment. This may be done by assuming a non-parametric empirical Bayes multinomial model and using rational function approximations to estimate the yield in new captures from continuing the experiment and capturing more instances. Known applications include genetic sequencing (an instance will be a sequenced genomic fragment), text mining (instances are words), census or epidemiology studies (instances are cases), species estimation (instances are individuals), software inspections (instances are faults or bugs), and activity monitoring on the internet (an instance is a visit to a website).

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIGS. 1A-E illustrate difficulties in predicting library complexity from initial shallow sequencing.

FIGS. 2A-D illustrate estimation of library complexity in terms of distinct molecules sequenced or distinct loci identified.

FIG. 3 illustrates the problem of duplicate reads. In the process of library preparation, the original DNA molecules are fragmented and then exponentially amplified by PCR to obtain enough genomic material for sequencing.

FIG. 4 illustrates how duplicate reads impact analysis. The exponential amplification of PCR means that any differences in amplification result in wildly different abundances.

FIG. 5 illustrates potential library complexity.

FIG. 6 illustrates problems in predicting complexity curves.

FIG. 7 illustrates the system in operation, with information from a “test run.” N_j is the number of reads observed j times.

FIG. 8 illustrates defining marginal yield of unique reads.

FIG. 9 illustrates a non-parametric empirical Bayes curve, demonstrating the Poisson factor.

FIG. 10 illustrates a formula for marginal yield.

FIG. 11 illustrates divergence.

FIG. 12 shows a rational function approximation of the present system, which eliminates the divergence in the Good-Toulmin model.

FIG. 13 illustrates use of continued fractions.

FIGS. 14-18 illustrate the results of applying the present system of predicting library complexity, using a single sperm donor for ongoing DNA methylation studies.

FIGS. 15 A-B illustrate bisulfite sequencing of the sperm in an initial experiment (FIG. 15A) and in a full experiment (FIG. 15B).

FIGS. 16A-B illustrate predicting ChIP-seq library complexity;

FIGS. 17A-B show the difficulty of sequencing RNA; and

FIG. 18 illustrates prediction of observed exons, with 1.28G covered by refSeq exons.

FIGS. 19-24A-B illustrate an embodiment of single-cell sequencing.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

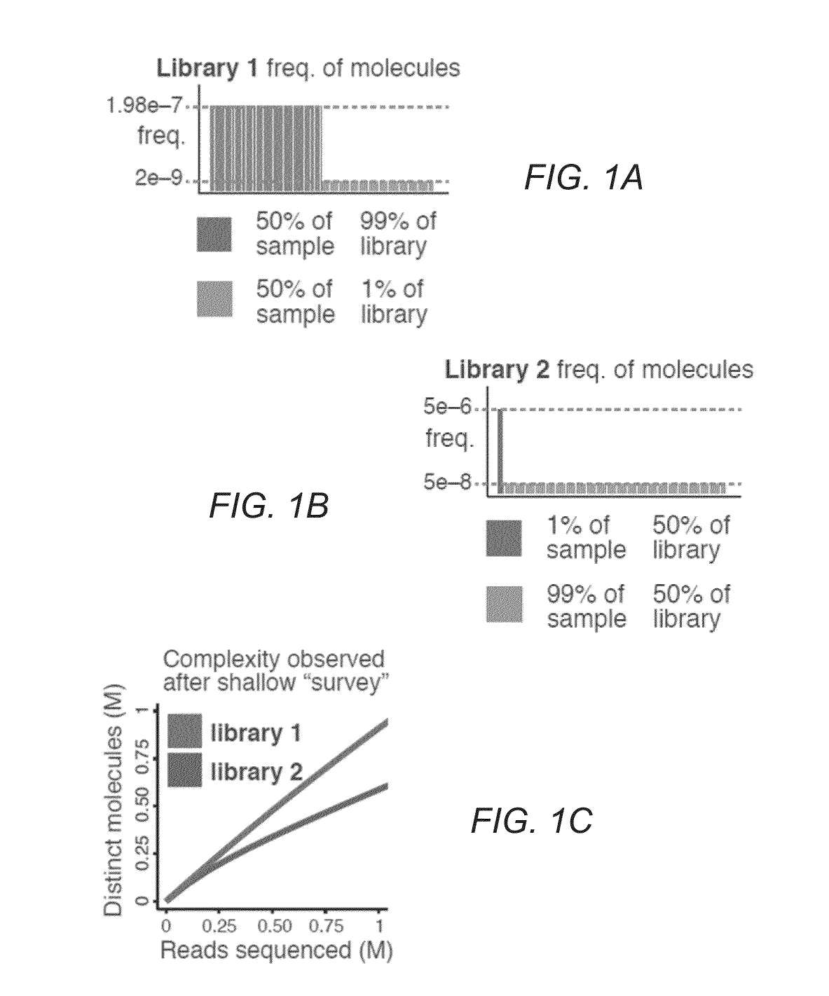

FIGS. 1A-E illustrate difficulties in predicting library complexity from initial shallow sequencing. FIG. 1A illustrates two hypothetical libraries containing 10 million (M) distinct molecules. Half of the molecules (5 M) make up 99% of library 1. FIG. 1B illustrates only 10,000 molecules that make up half of library 2. FIG. 1C demonstrates based on a shallow sequencing run of 1 M reads, that library 1 appears to contain a greater diversity of molecules. FIG. 1D shows after additional sequencing, library 2 yields more distinct observations. FIG. 1E illustrates similar situations occurring in practice. Initial observed complexity from 5 M reads for two bisulfite sequencing libraries indicates that human sperm is the more complex library, but observed library complexity curves cross after additional sequencing, with the Chimp Sperm library yielding more distinct reads. Estimates using Rational Function (RF) and Euler's transform (ET) fit to initial experiments predict crossing (though ET becomes unstable), while zero-truncated negative binomial (ZTNB) does not.

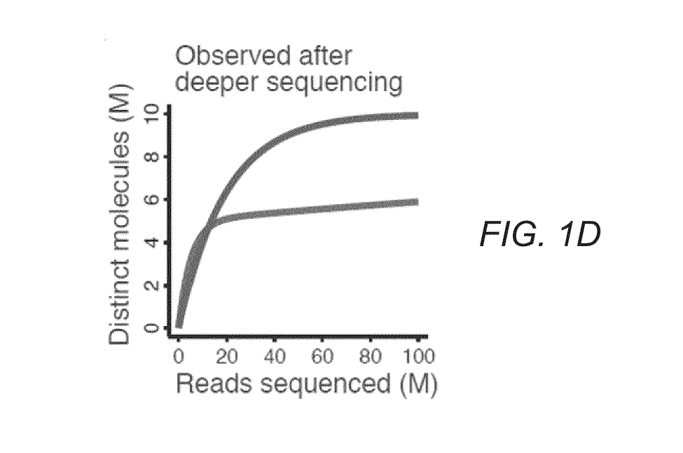

FIGS. 2A-D illustrate estimation of library complexity in terms of distinct molecules sequenced or distinct loci identified. FIG. 2A: ChIP-seq library (CTCF; mouse B-Cells) yields additional distinct molecules after sequencing 100 M reads; the RF remains accurate while the ZTNB loses accuracy. FIG. 2B: In the same library, the number of mapped distinct genomic 1 kb windows saturates after 25 M reads. The RF is accurate and forecasts saturation, while the ZTNB significantly overestimates the amount of sequencing needed for saturation. FIGS. 2C: An RNA-seq (Human adipose-derived mesenchymal stem (ADS) cells) library continues to yield additional molecules after 200 M reads; the RF remains accurate while the ZTNB predicts saturation. FIGS. 2D: In the same library, reads continued mapping to new 300 bp windows after 200 M reads. ZTNB incorrectly predicts saturation, while RF does not.

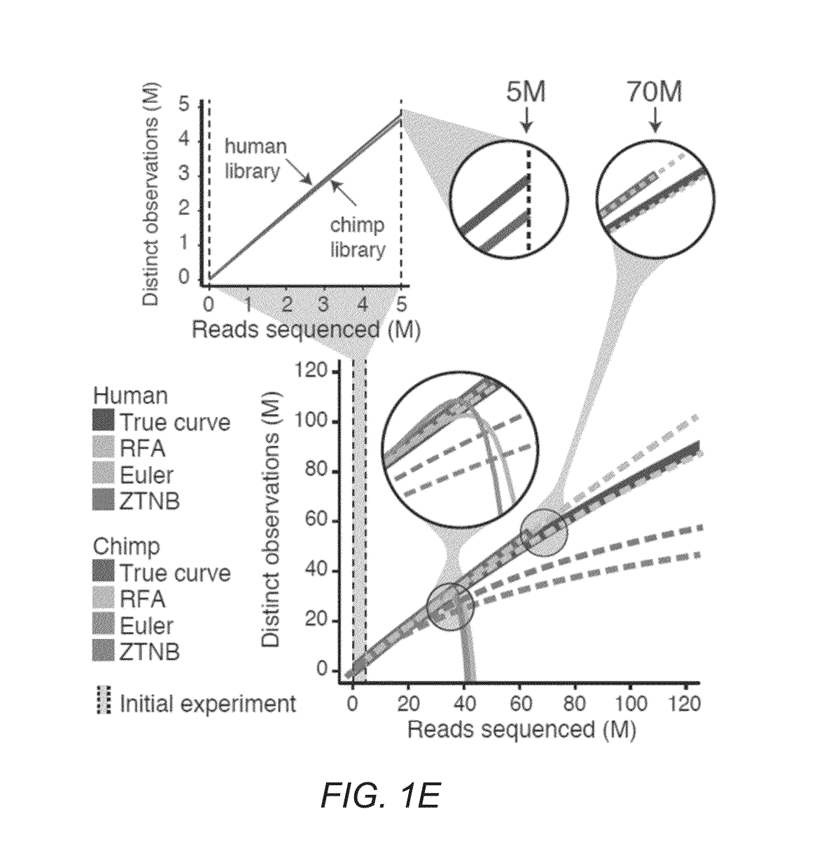

FIG. 3 illustrates the problem of duplicate reads. In the process of library preparation, the original DNA molecules are fragmented and then exponentially amplified by PCR to obtain enough genomic material for sequencing. The PCR amplification implies that there are a lot of copies of each molecule (and I mean a lot). The fragments are then sequenced and mapped.

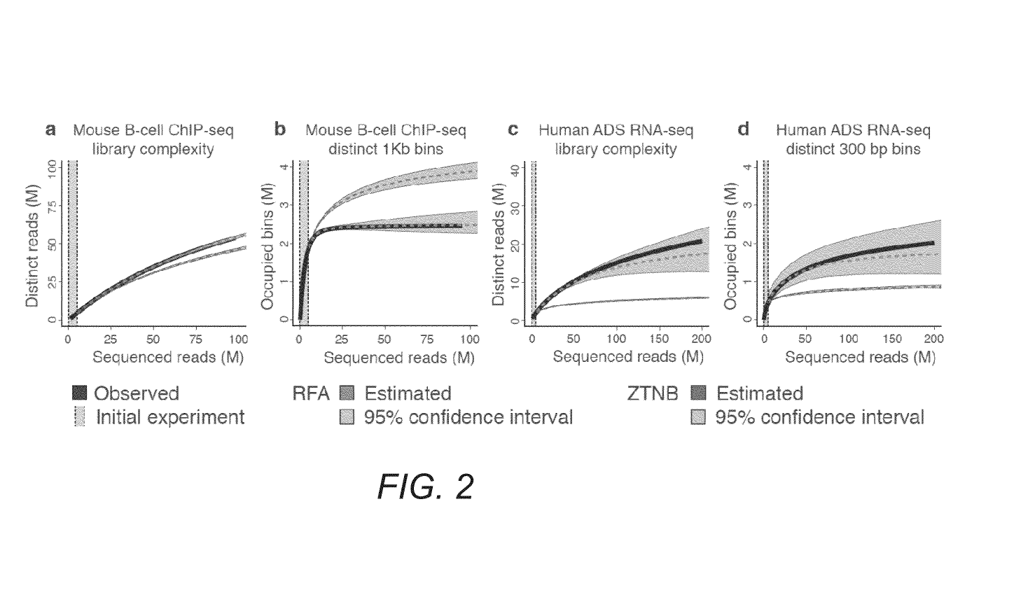

FIG. 4 illustrates how duplicate reads impact analysis. The exponential amplification of PCR means that any differences in amplification result in wildly different abundances. These reads may be severely overrepresented in a library. This may have a profound effect on downstream analysis. In calling peaks we may think an overrepresented read is a peak when it is just a jackpot. In calling SNPs, we may think a SNP is there but is due to a PCR error and preferential amplification. Accordingly, most analyses throw out duplicates reads. A method to correct this is to use random barcodes to identify PCR duplicates from true molecular duplicates.

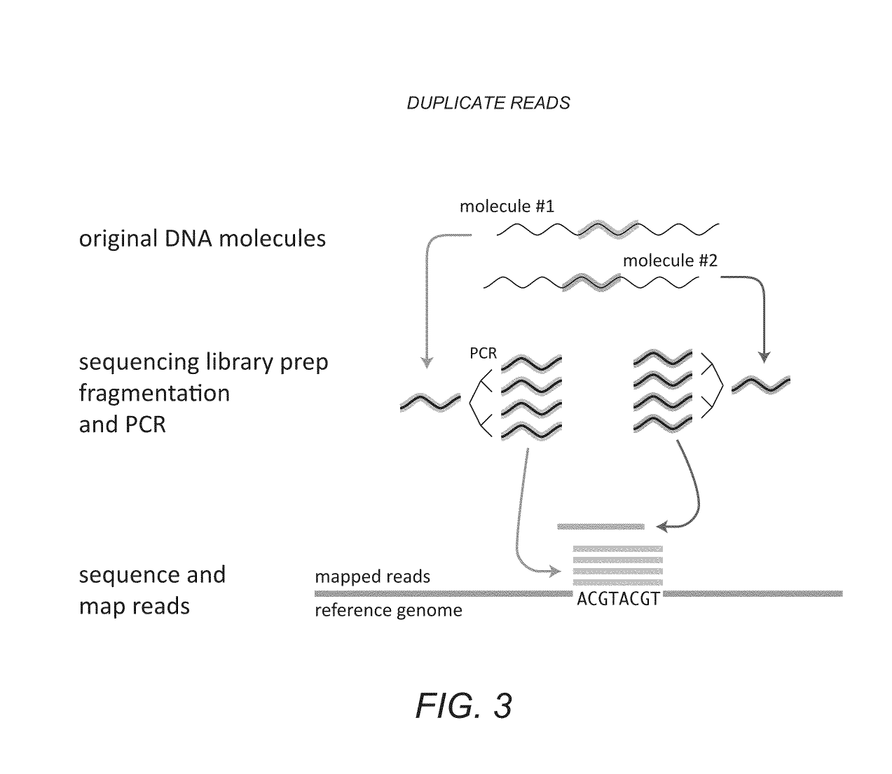

FIG. 5 illustrates potential library complexity. It is not just about the PCR. Other factors are adaptor ligation bias, ligation bias, in RNA-seq, reverse transcription, and solid-phase amplification (Illumina).

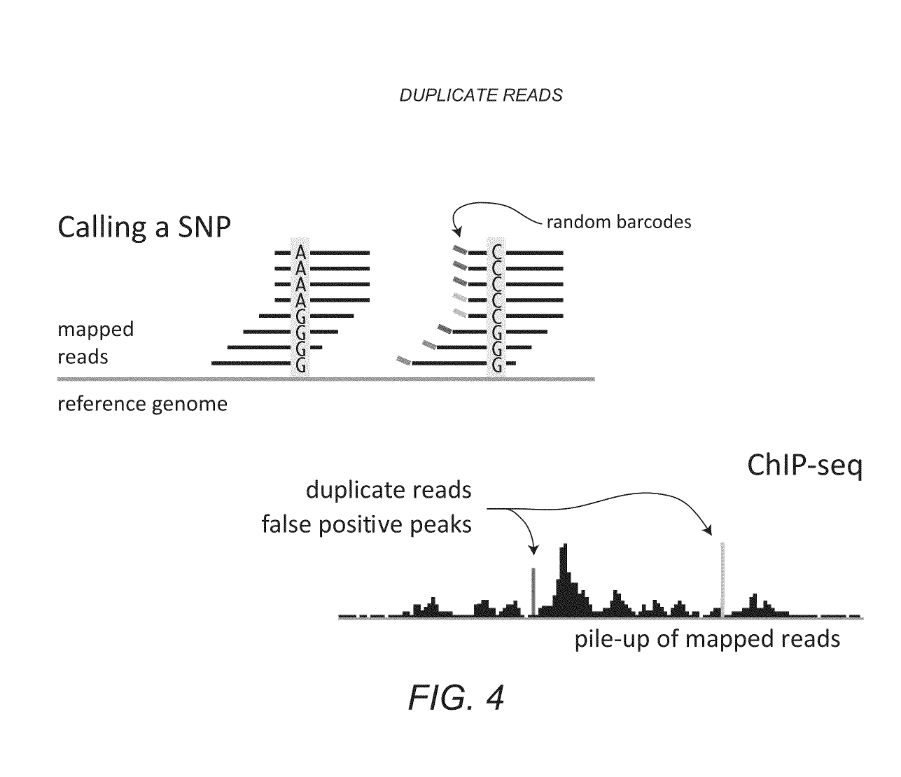

FIG. 6 illustrates problems in predicting complexity curves.

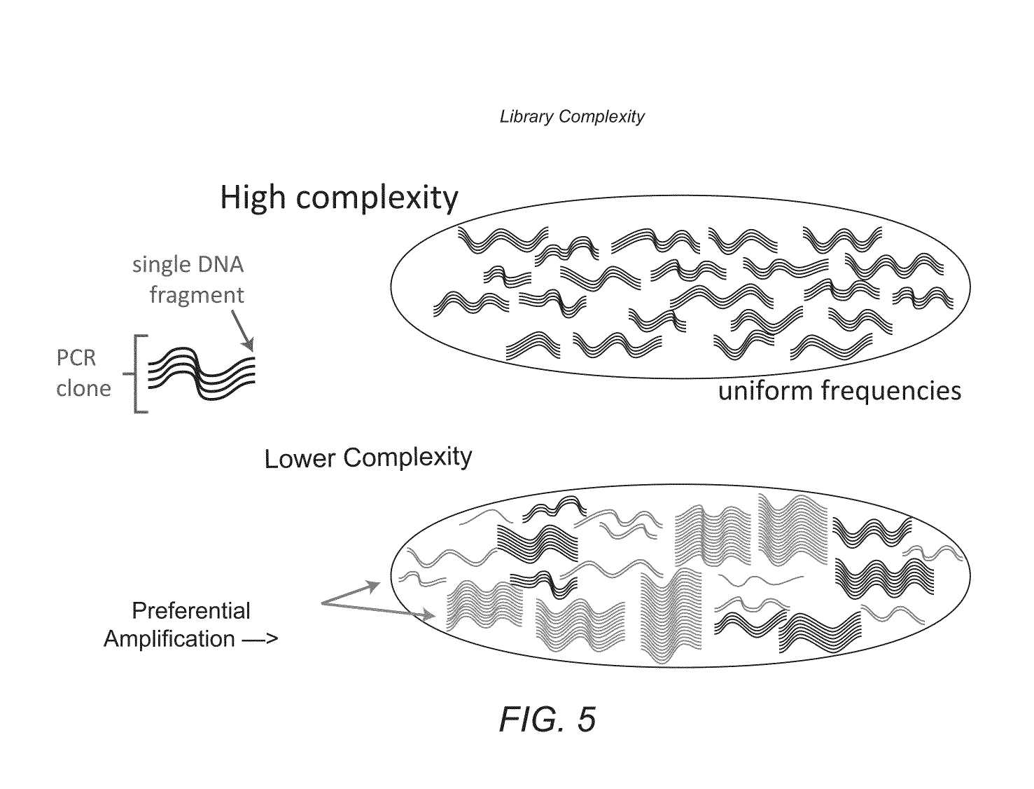

FIG. 7 illustrates the system in operation, with information from a “test run.” N_j is the number of reads observed j times. The set of all duplicate counts is called the counts histogram. Regardless of assumptions, the counts histogram is a sufficient statistic.

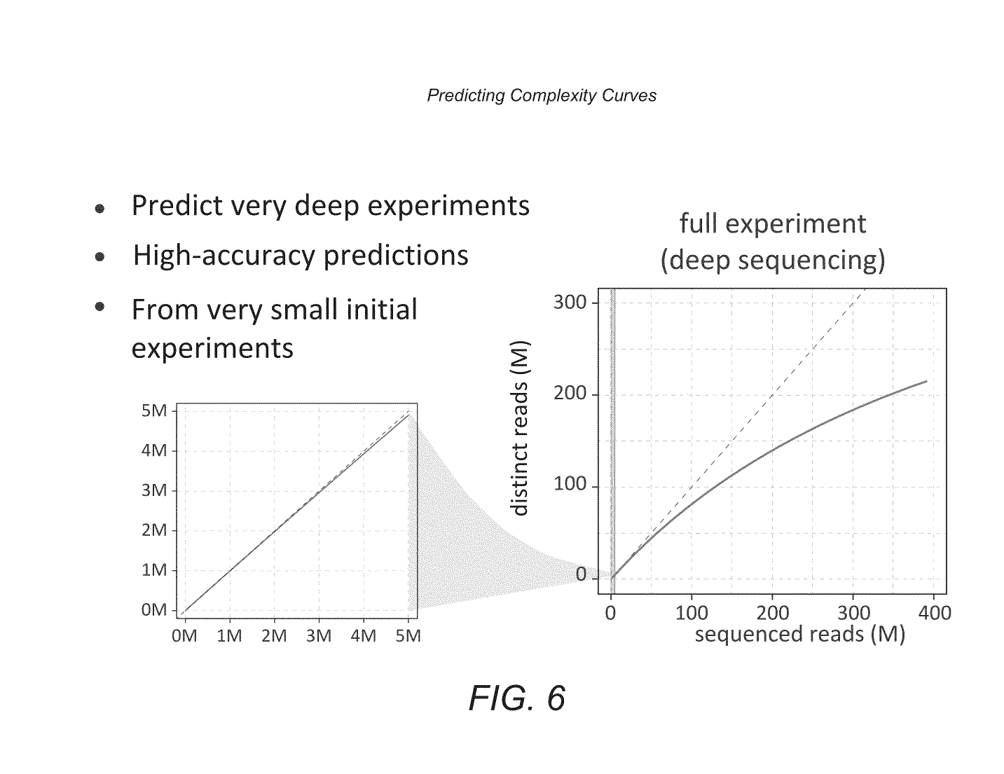

FIG. 8 illustrates defining marginal yield of unique reads. The change in the number of reads observed is also the change in the number of unobserved reads.

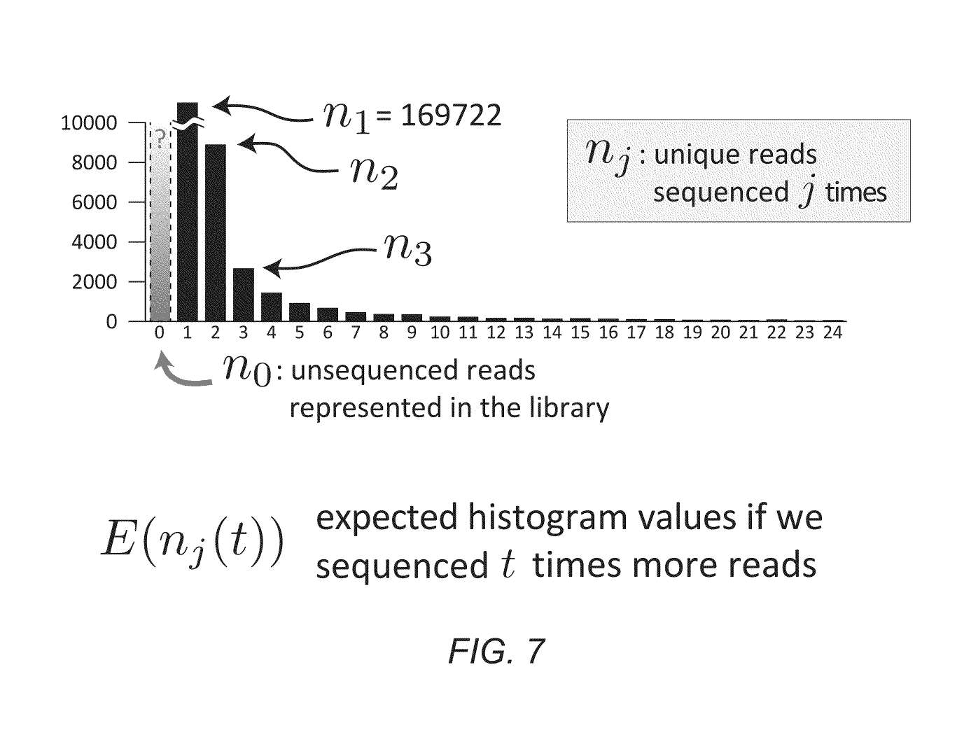

FIG. 9 illustrates a non-parametric empirical Bayes curve, demonstrating the Poisson factor. The system may be integrating over an arbitrary distribution. The expectation may be defined with t relative to N.

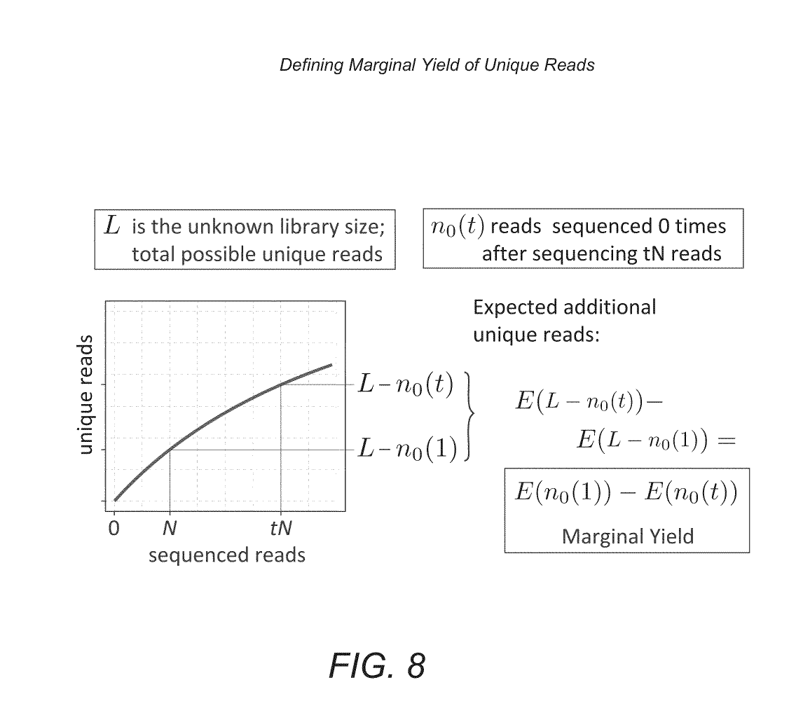

FIG. 10 illustrates a formula for marginal yield.

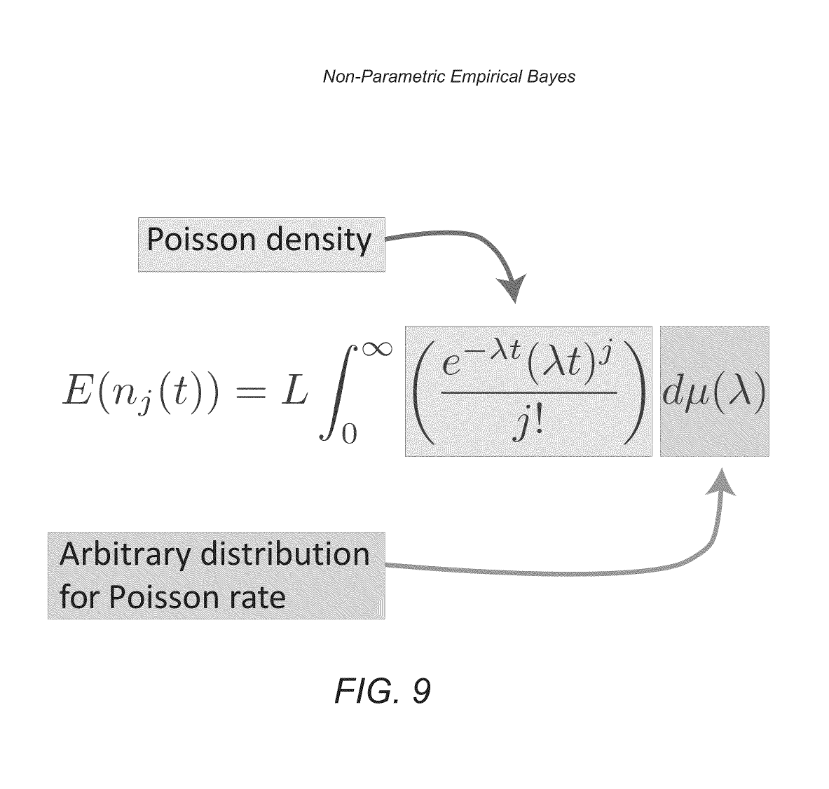

FIG. 11 illustrates divergence. The Good and Toulmin estimator is UMVUE for extrapolating up to 2-fold.

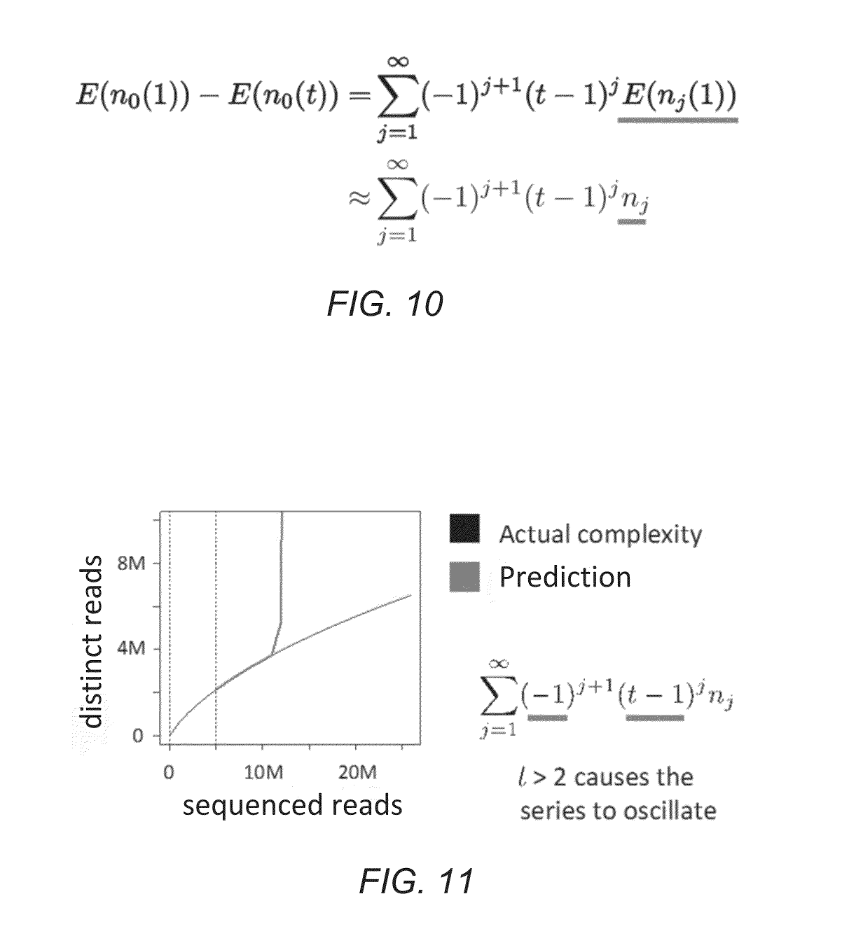

FIG. 12 shows a rational function approximation of the present system, which eliminates the divergence in the Good-Toulmin model. Alternating power series usually have a small radius of convergence due to blow up for negative numbers.

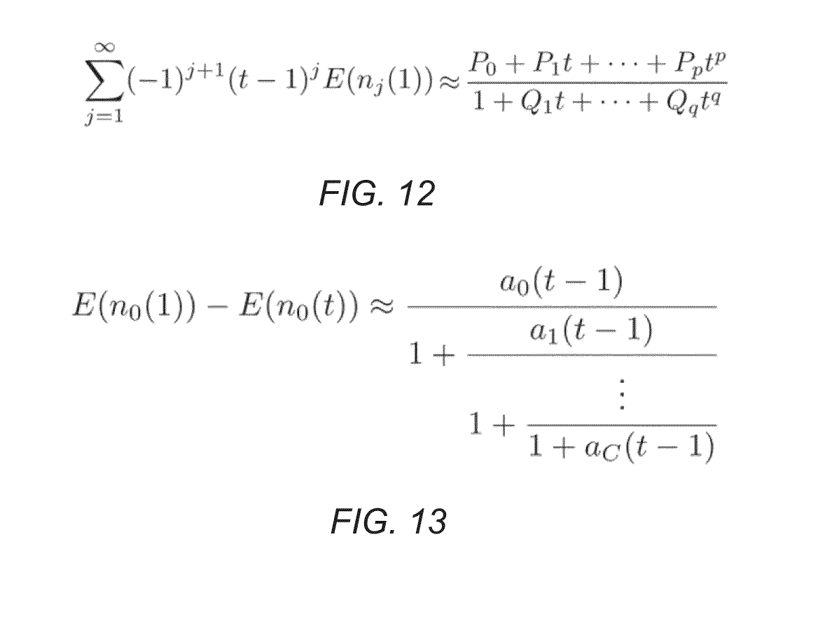

FIG. 13 illustrates use of continued fractions. Advantages include efficient and numerically stable algorithms to fit and evaluate the rational function; quotient difference algorithm is quadratic versus cubic for the traditional method of inverting the Hankel matrix, which can be very ill-conditioned; Euler's recursion with renormalization prevents blow up for large power of t.

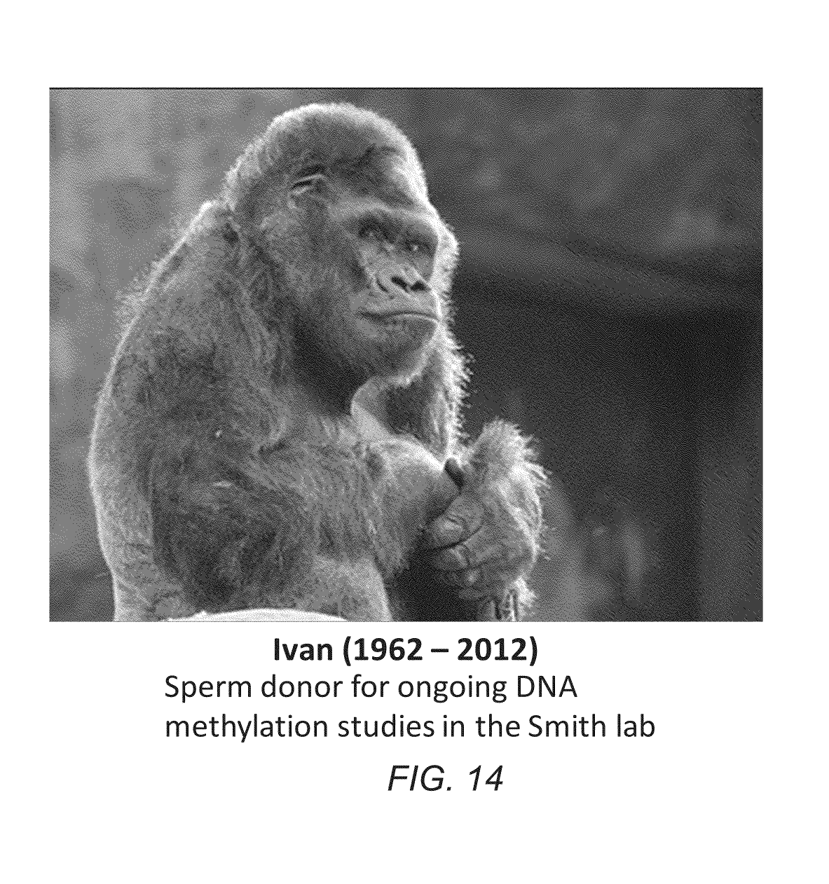

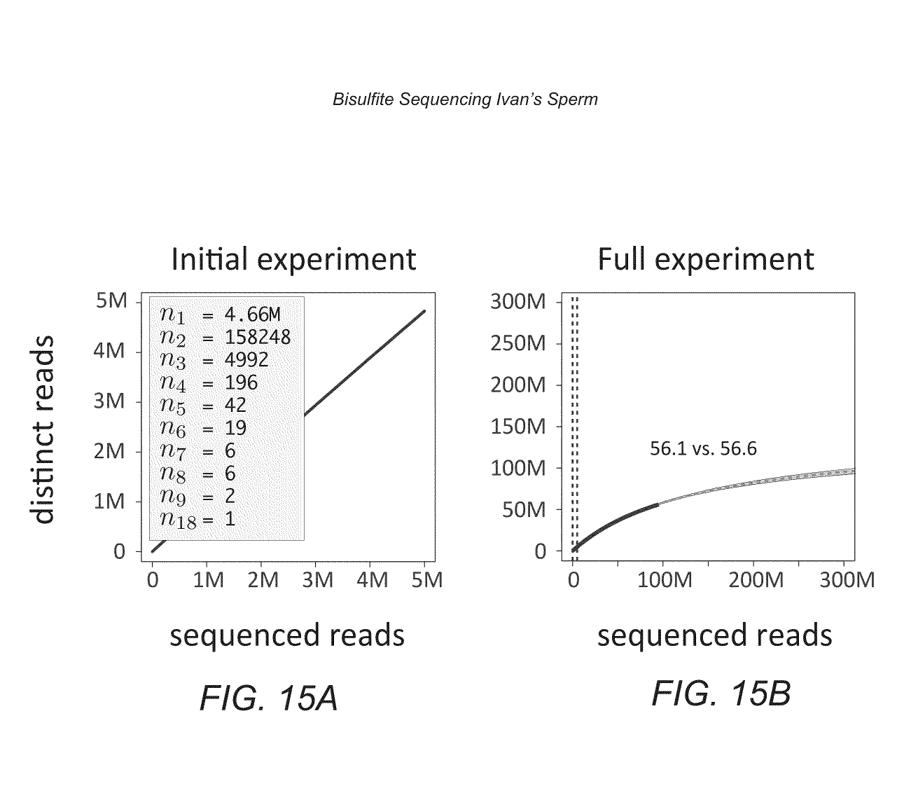

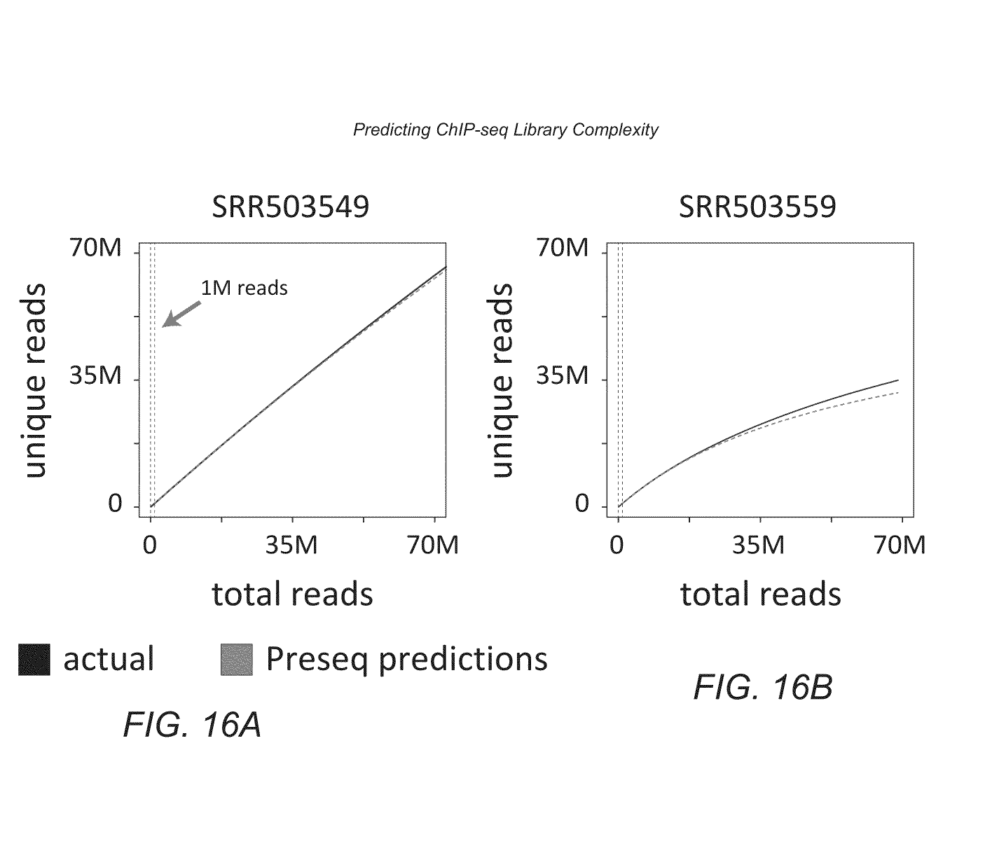

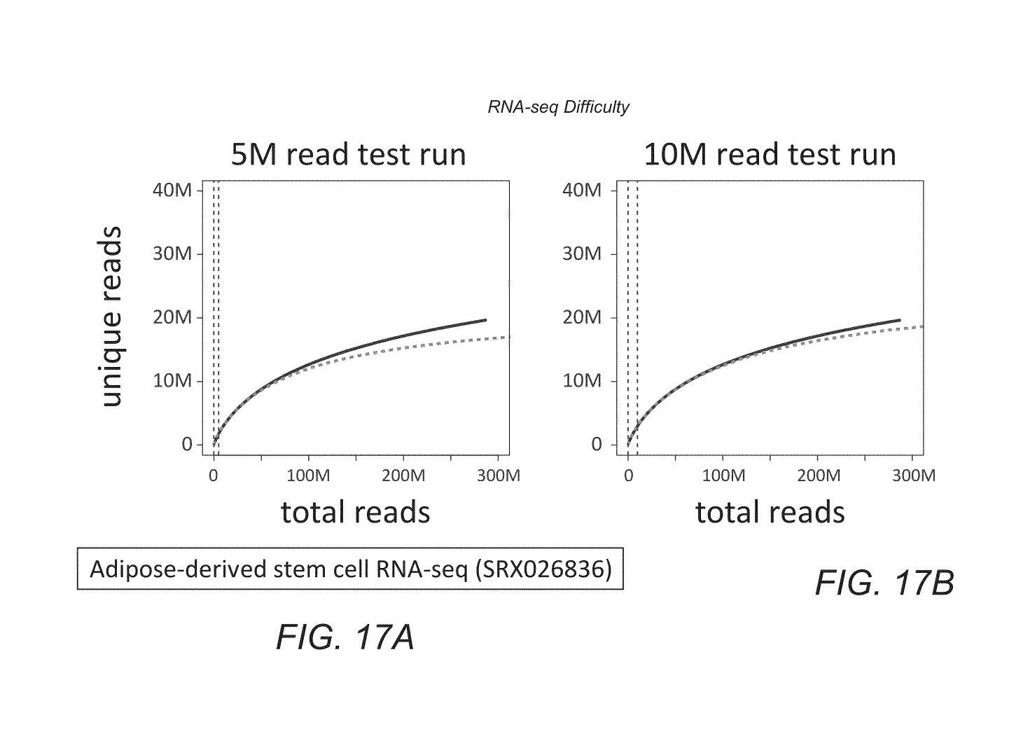

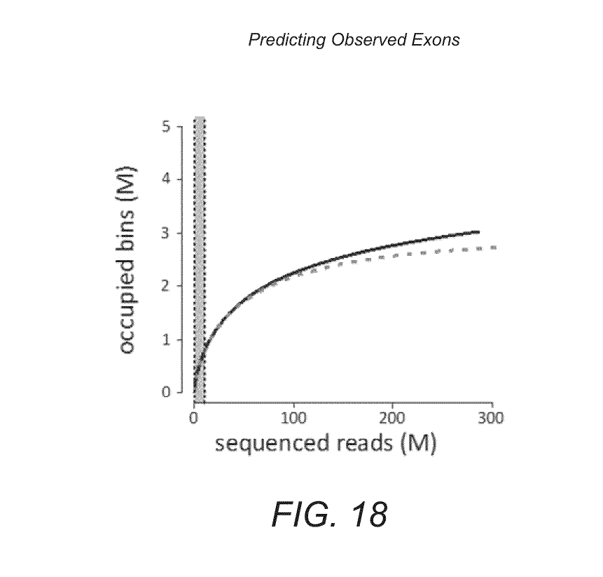

FIGS. 14-18 illustrate the results of applying the present system of predicting library complexity, using a single sperm donor for ongoing DNA methylation studies. FIGS. 15 A-B illustrate bisulfite sequencing of the sperm in an initial experiment (FIG. 15A) and in a full experiment (FIG. 15B). Results included 3% duplicate in initial experiment; 56.6 vs 56.1 distinct in full experiment (˜96M reads) 41% duplicates. FIGS. 16A-B illustrate predicting ChIP-seq library complexity; FIGS. 17A-B show the difficulty of sequencing RNA; and FIG. 18 illustrates prediction of observed exons, with 1.28G covered by refSeq exons.

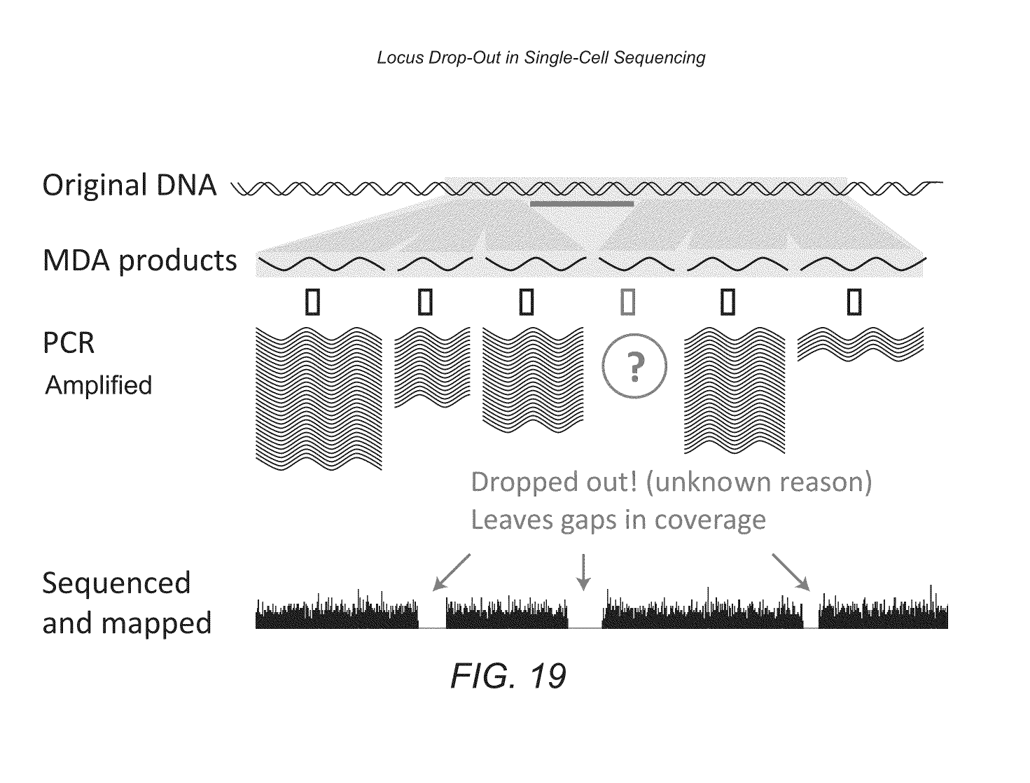

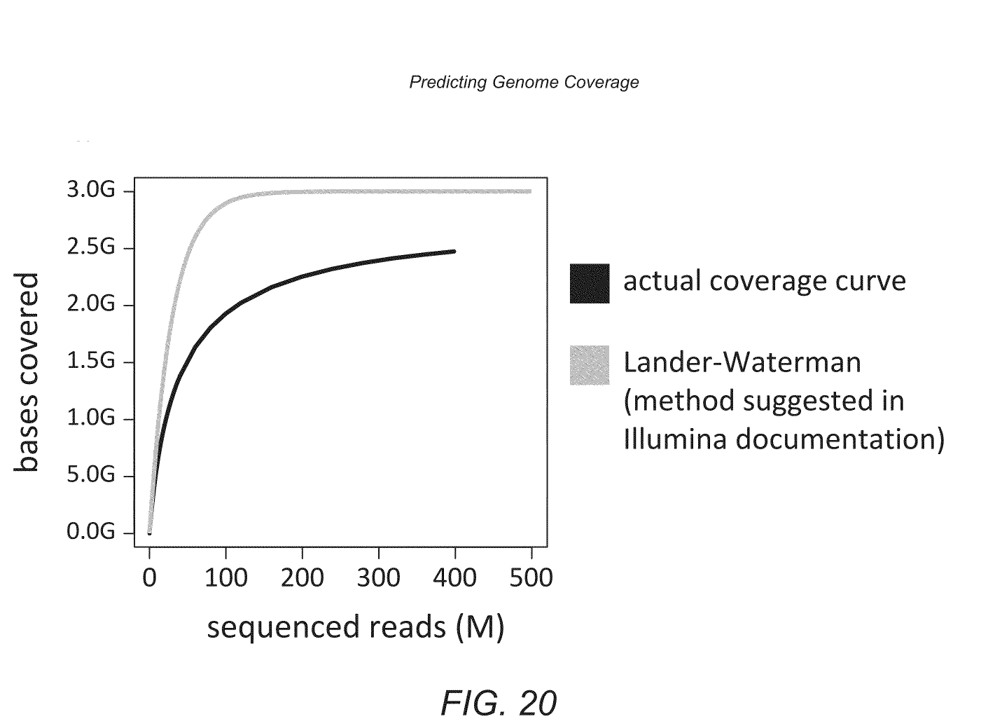

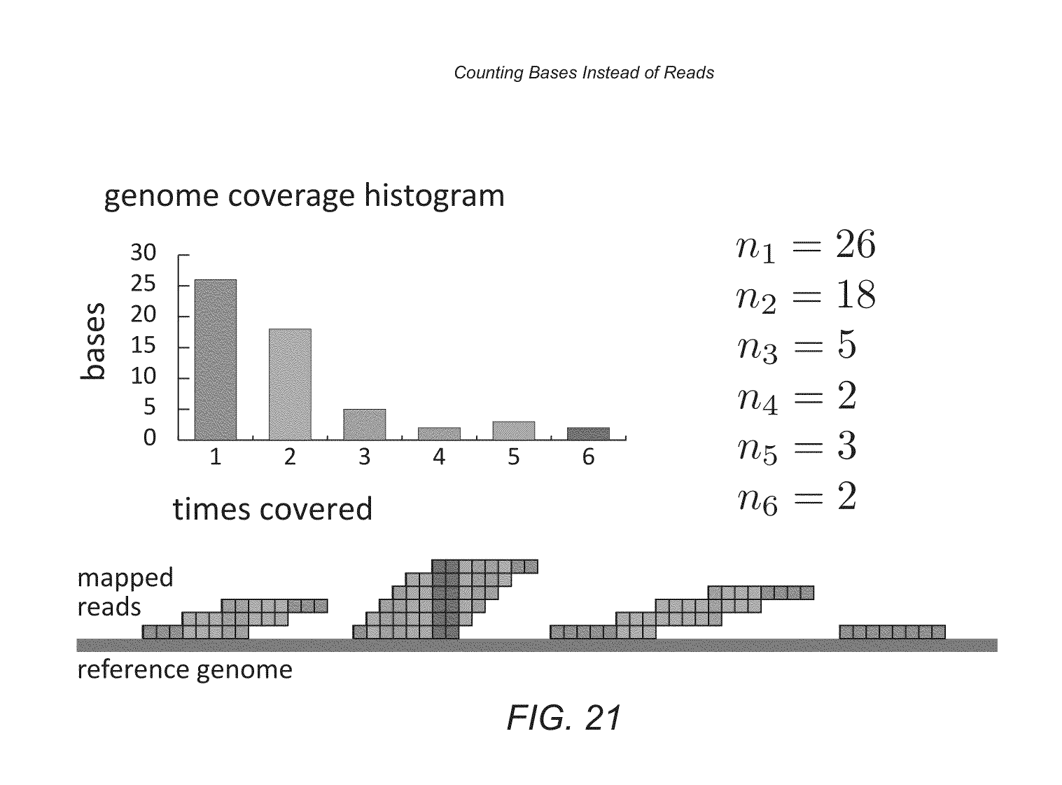

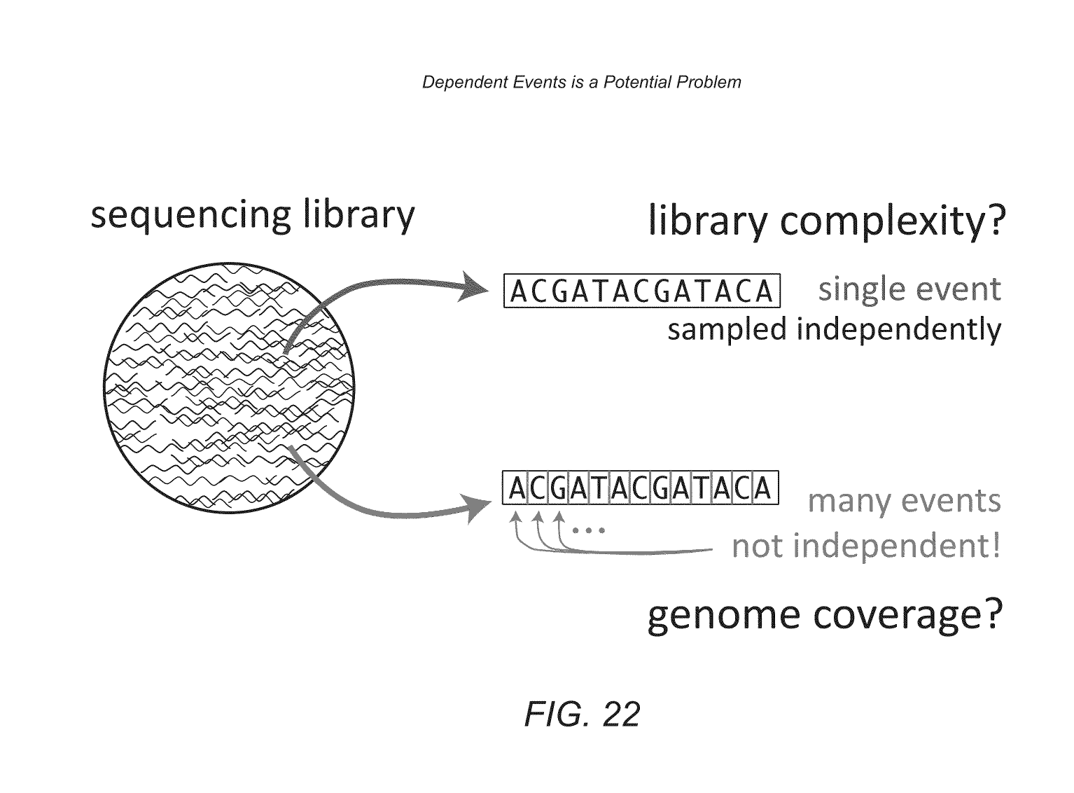

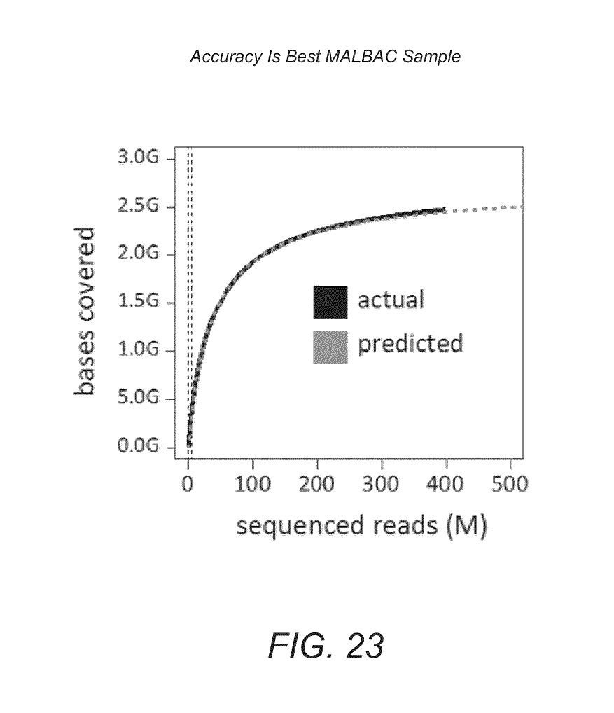

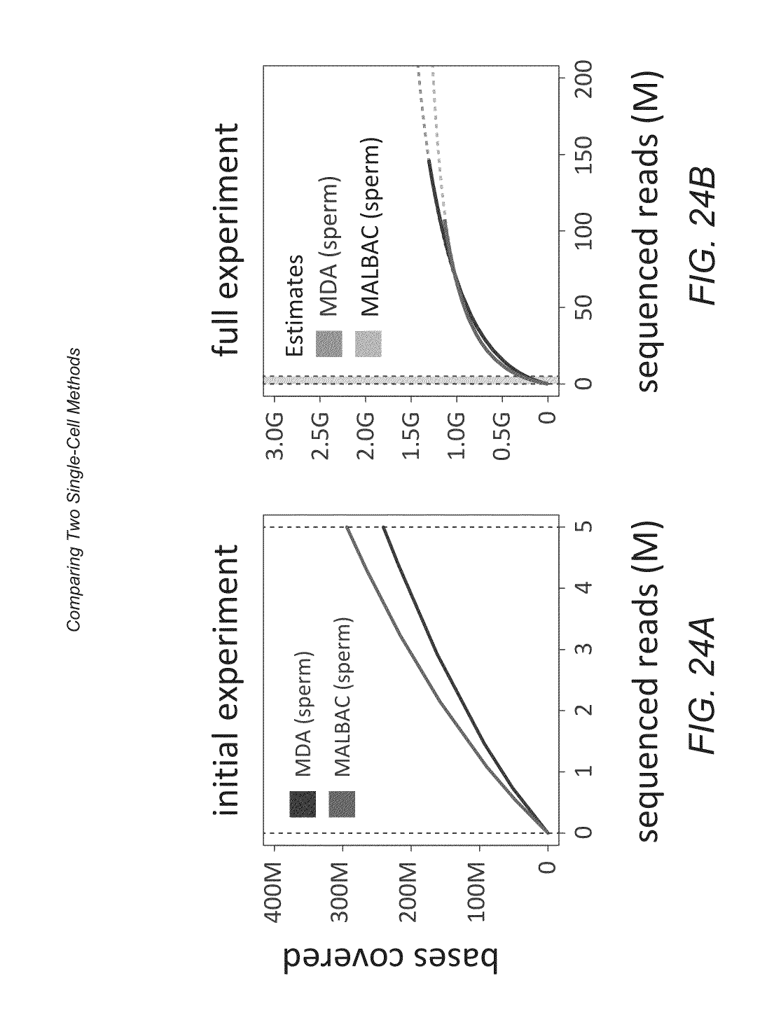

FIGS. 19-24A-B illustrate an embodiment of single-cell sequencing. The question of how much of the genome will be covered. In the reaction shown in FIG. 19, random primers are extended by a strong strand-displacing enzyme, the phi29 DNA polymerase. As the polymerase extends the growing DNA strands, it displaces downstream strands resulting in a branching form of amplification.

An empirical Bayes method may predict the molecular complexity of sequencing libraries or samples based on data from very shallow sequencing runs. We define complexity as the expected number of distinct molecules that can be observed in a given set of sequenced reads (see Chen Y. et al. Nat. Methods, Vol. 9, pages 609-614 (2012). This function, which we call the complexity curve, efficiently summarizes new information to be obtained from additional sequencing and is generally robust to variation between sequencing runs. Importantly, our method also applies to understanding the complexity of molecular species in a sample (e.g. RNA from different isoforms), and since we require no specific assumptions about the sources of biases, our method is applicable in a surprising variety of contexts.

Consider a sequencing experiment as sampling at random from a DNA library. Distinct molecules in the library have different probabilities of being sequenced, which we assume will change very little upon deep sequencing of the same library. Our goal is to accurately estimate the number of previously unsequenced molecules that would be observed if some number of additional reads were generated.

Capture-recapture statistics has dealt with analogous questions of estimating animal population size or species diversity (Fisher, R. A., Corbet, S. & Williams, C. B., J. Anim. Ecol., Vol. 12, pages 42-58 (1943)). Here, the classic Poisson non-parametric empirical Bayes model of Good and Toulmin (Good, I. J. & Toulmin, G. H., Biometrika, Vol. 43, pages 45-63 (1956)) may be borrowed for the problem of read sampling. Based on the initial sequencing experiment, we identify unique molecules by some unique molecular identifier (Kivioja, T. et al., Nat. Methods, Vol. 9, pages 72-74 (2012)) and obtain the frequency of each unique observation (e.g., each genomic position, transcript, allele, etc.). These frequencies are used to estimate the expected number of molecules that would be observed once, twice, and so on, in an experiment of the same size from the same library. The formula takes the form of an alternating power series with the estimated expectations as coefficients (full derivation provided in Online Methods).

The power series is extremely accurate for small extrapolations but major problems are encountered when attempting to extrapolate past twice the size of the initial experiment (see Good & Toulmin, cited herein). At that point, the estimates show extreme variation depending on the number of terms included in the sum. Technically, the series is said to diverge and therefore cannot be used directly to make inferences about properties of experiments more than twice as large as the initial experiment. Methods traditionally applied to help these series converge in practice, including Euler's series transformation (Efron, B. & Thisted, R., Biometrika, Vol. 63, pages 435-447 (1976)), are not sufficient when data is on the scale produced in high-throughput sequencing experiments or for long-range predictions.

We investigated a technique called rational function approximation, which is commonly used in theoretical physics (Baker, G. & Graves-Morris, P. Pade Approximants (Cambridge University Press, Cambridge, UK, 1996). Rational functions are ratios of polynomials that, when used to approximate a power series, often have a vastly increased radius of convergence. Algorithms to fit a rational function approximation essentially rearrange the information in the coefficients of the original power series, under the constraint that the resulting rational function closely approximates the power series. The convergence properties of rational function approximations are known to be especially good for a class of functions that includes the Good-Toulmin power series (discussion in Supplementary Note).

By combining the Good-Toulmin power series with rational function approximations, an algorithm has been developed that can make optimal use of information from the initial sample and accurately predict the properties of sequencing data sets several orders of magnitude larger than the initial “shallow” sequencing run. We implemented our methods as a command line software package licensed under GPL and available as Supplementary Software or at http://smithlab.usc.edu/software.

A toy example illustrates how naive analysis can lead to incorrect complexity predictions (FIGS. 1A-D). In the example, two hypothetical libraries have complexity curves that initially appear linear (FIG. 1C) but eventually cross (FIG. 1D). Such extreme behavior can actually arise in practice. We used a small sample of reads (i.e., the initial sample) from human and chimp sperm bisulfite sequencing experiments (Molaro, A. et al., Cell, Vol. 146, pages 1029-1041 (2011)) and produced complexity curves for the libraries (FIG. 1E). Both complexity curves appear linear in the initial 5 million (M) read experiment, with the chimp library curve exhibiting a lower trajectory; on this basis a naive analysis might predict the chimp library to saturate first. However, the complexity curves cross after deeper sequencing (at 22 M reads), with the chimp library yielding more distinct observations.

Based on the initial sample of 5 M reads, the complexity of these two libraries may be estimated using the rational function approximation (RF), as well as Euler's transform (ET) and a zero-truncated negative binomial (ZTNB). The ZTNB is the natural next step to model count data that is not Poisson distributed, and the ET is the traditional method used to improve convergence of the Good-Toulmin series. The ET method initially gives accurate estimates, but these diverge and are useless after 40 M reads. The ZTNB estimates show a substantial downward bias (more than 35% error for both libraries) and do not predict that the complexity curves cross, indicating that this distribution fails to account for library biases. The RF method estimates the complexity of both libraries almost perfectly, and in the case of the chimp library, this amounts to extrapolating to 60 times the size of the initial sample while only incurring 4% error (human library) or well under 1% error (chimp library).

In sequencing applications that identify genomic intervals such as protein binding sites in chromatin immune-precipitation and sequencing (ChIP-seq) or expressed exons in RNA sequencing (RNA-seq), the number of distinct molecules in the library might be of secondary interest to the number of distinct genomic intervals identified after processing mapped reads. To demonstrate the broad applicability of the present method (further discussed below in Supplementary Note), the efficacy of the method in predicting the number of non-overlapping genomic windows identified in a ChIP-seq experiment (1 kb) and an RNA-seq experiment (300 bp) using an initial 5 M reads was investigated. The non-overlapping windows are used for simplicity, but more sophisticated methods of identifying binding sites or exons are equally applicable. For the ChIP-seq experiment (CTCF; mouse B-cells, see de Almeida, C. R. et al., Immunity, Vol. 35, pages 501-513 (2011)), the number of distinct reads did not reach saturation even after sequencing 90 M (FIG. 2A), while the number of identified windows saturated after approximately 25 M reads (FIG. 2B). The RF predicted this saturation correctly (FIG. 2B) and estimated library complexity with very high accuracy (FIG. 2A). The ZTNB over-estimated the saturation of identified windows at 4 M, more than possible in the mouse genome, while significantly under-estimating the yield of distinct reads. The RNA-seq experiment (Human adipose-derived mesenchymal stem cells, see Lister, R. et al., Nature, vol. 471, pages 68-73 (2011)) did not saturate for either distinct reads (FIG. 2C) or identified windows (FIG. 2D), suggesting additional sequencing from this library would yield more information. Only the RF accurately predicted absence of saturation for both windows and reads, showing significantly lower relative error than the ZTNB at 200 M sequenced reads.

Sequencing data will always be subject to some amount of technical variation between sequencing instruments or even between runs on the same machine. We applied our method to data from a single library sequenced on different instruments (using slightly differing sequencing technologies), and found that complexity estimates are within the range expected due to stochastic noise. To impact the library complexity estimates, run-to-run variation must be dramatic and would likely be caused by detectable sequencing error at levels sufficient to warrant discarding the run.

As the cost, throughput, and read lengths of sequencing technologies improve, the usefulness of methods for understanding molecular complexity in a DNA sample will increase. The approach we have described, based on rational function approximation to the power series of Good & Toulmin (see Good & Toulmin, cited herein), can be applied to an immense diversity of sequencing applications (see Supplementary Note, below). As the age of clinical sequencing approaches, significant resources will be dedicated to refining quality control, protocol optimization and automation; methods for evaluating libraries will be essential to controlling costs and interpreting the results of sequencing that potentially could inform clinical decisions.

### Methods

Modeling the Sequencing Process

Consider a sequencing experiment in which a total of M=tN reads are sequenced, for some 1<t<∞ and N<M. We fix a size N subset of the reads and refer to this subset as the initial experiment. The remaining (t−1)N reads are sequenced from the same library in the extended experiment and we refer to the union of the initial and extended experiment as the complete experiment. Although our terminology might suggest that the initial and extended experiments are conducted separately and at different times, this is not necessary and we only require that the properties of the library are unchanged between the initial and extended experiments. Concretely, we assume the total number of distinct genomic molecules contained in the library remains constant as well as the underlying properties of the library, such as the relative frequencies of the fragments. We seek to use the information obtained during the initial experiment to determine properties of the complete experiment, in particular the number of molecules sequenced in the complete experiment that were unsequenced in the initial experiment.

Estimating the Yield of a Library

The following derivation closely follows that of Efron & Thisted⁶. Let nⱼ(t) denote the number of molecules sequenced j times in the complete experiment and let nⱼ=nⱼ(1) be the number of molecules sequenced j times in the initial experiment. Assume that L is the unobserved true total number of distinct molecules in the library and π={πᵢ; i=1, . . . , L} are the probabilities, for each molecule in the library, that a sequenced read corresponds to that molecule. Furthermore assume that πᵢ>0 for all i, so that L includes only those molecules that are in the library and can be observed and identified. Define λᵢ=Nπᵢ and assume each λᵢ is independently and identically distributed according to distribution μ(λ) with finite second moment. We assume the number of reads observed from molecule i follows a Poisson process with rate λᵢ. Therefore if tN reads are sequenced, the expected number of molecules observed j times is

$$E ( {n}_{j} ( t ) ) = L {\int }_{0}^{∞} {{e}^{- λ t} ( λ t )}^{j} / j ! d μ ( λ ) . \qquad Equation 1$$

Let Δ(t) denote the marginal yield between the initial and complete experiments, equal to the increase in the number of distinct observed reads resulting from the extended experiment. This is equal to the expected number of unobserved reads following the initial experiment minus the expected number of unobserved reads following the complete experiment:

$$\begin{matrix}Δ ( t ) = E ( {n}_{0} ( 1 ) ) - E ( {n}_{0} ( t ) ) \\ = L {\int }_{0}^{∞} {e}^{- λ} ( 1 - {e}^{- λ ( t - 1 )} ) d μ ( λ ) \\ = {\sum }_{j = 1}^{∝} {( - 1 )}^{j + 1} {( t - 1 )}^{j} E ( {n}_{j} ( 1 ) ) .\end{matrix} \qquad Equation 2$$

The last equality is obtained by expanding 1−exp(−λ(t−1)) as a power series centered at t=1, reordering the integration and summation, and invoking identity (1). Since the observed frequency of count j is always an unbiased estimator for E(nⱼ(1)) regardless of the distribution μ,

$$Δ ( t ) = {\sum }_{j = 1}^{∞} {( - 1 )}^{j + 1} {( t - 1 )}^{j} {n}_{j} \qquad Equation 3$$

is an unbiased estimator for the marginal library yield. Therefore, an unbiased estimator of the total library yield can be calculated by adding the marginal yield and the observed number of distinct reads in the initial experiment. The case of extrapolating to t=∞ is equivalent to estimating the library size L, which is a desirable quantity, but is unidentifiable and therefore has no unbiased estimator without additional assumptions (see Link, W. Biometrics, Vol. 59, pages 1123-1130 (2003) and Mao, C. & Lindsay, B. Ann. Stat., Vol. 35, pages 917-930 (2007)).

This elegant result, originally derived in the 1950's (Good & Toulmin, cited herein), presents substantial difficulties in direct practical application. Equation 3 is only guaranteed to converge for t≦2, which corresponds to extrapolating to only twice the number of observations in the initial experiment. Accordingly, most applications of this formula are restricted to this range. Applications associated with deep sequencing, however, require accurate estimates far outside this range, implying we need to increase the radius of convergence of the power series. Previously suggested methods, such as Euler's transformation, do not perform well for large values of t, even for experiments significantly smaller than a typical sequencing experiment¹³.

Rational Function Approximation

Euler's transformation is a common tool in increasing the radius of convergence for divergent series or to speed up the rate of convergence for difficult to sum series, particularly alternating series¹⁴. The transformed series is a power series in the variable u=2(t−1)/t, so that the transformed series form is a rational function in t. We hypothesized that more accurate results would be obtained by considering approximations in this larger class. For a given function and its power series, the coefficients of the optimal rational function approximation of fixed degrees P and Q (Equation (2) below), are determined by requiring the first P+Q+1 coefficients of the associated power series to be equal to the first P+Q+1 coefficients of the original power series (i.e. Equation (3)) (Baker, G. & Graves-Morris, P. Pade approximants, cited and incorporated by reference herein). The fundamental idea is that the initial experiment gives us reliable information on how the function behaves in a neighborhood around t=1; our approximation should use this information while remaining globally well-behaved.

Rational function approximations can be shown to converge for a wide variety of functions⁷ but are more useful for approximating certain classes of functions. One such class is the set of alternating power series with coefficients arising from moments of a positive measure on the real line—including the familiar probability measures. Such power series are often called series of Stieltjes (Simon, B. Adv. Math. 137, 82-203 (1998), incorporated by reference herein). The power series of Equation (2) falls within this class when the true expected frequencies, E(nⱼ(1)), are known exactly. Clearly we can only estimate the E(nⱼ(1)), which we do by counting reads. However, the absolute amount of information contributing to our estimates of the E(nⱼ(1)) is extremely large, especially when we compare the number of reads sequenced in a small sequencing run (i.e. millions) with the numbers arising from traditional capture-recapture experiments, e.g., hundreds (see Keating, K., Quinn, J., Ivie, M., & Ivie, L. Ecol. Appl. Vol. 8, pages 1239-1249 (1998)) or thousands (Kivioja T. et al., cited and incorporated by reference herein) of captures.

When applied to Stieltjes series, rational function approximations have the fascinating property that the direction of their convergence depends on the relationship between the order of the polynomials in the numerator and denominator¹⁵. If the order of the approximation (P+Q+1) is odd then convergence is from below. For a fixed t, successive approximations obtained from increasing both P and Q by one increase towards the true value. This implies that any odd order approximation will be conservative when the E(nⱼ(1)) are known exactly. If the order is even then the convergence is from above and the resulting approximations may be liberal. We can therefore choose to only consider odd order approximations and our estimates will tend to be conservative.

Two common and equivalent implementations of rational function approximations are Pade approximants and truncated continued fractions. We chose to implement the approximations using continued fractions for several reasons. First, computing the coefficients for a truncated continued fraction expansion is both asymptotically faster and numerically more stable than directly computing the Padé approximant coefficients. Using the quotient-difference algorithm, the coefficients of the continued fraction can be computed in time that is a quadratic function of the degree of the truncated power series being approximated (McCabe, J. H. Math. Comp. Vol. 41, pages 183-197 (1983)). The straightforward methods typically associated with Pade approximants require inverting a matrix (often ill-conditioned), which requires cubic time and may be numerically unstable.

Second, representing rational functions as continued fractions easily circumvents direct evaluation of the high-order polynomials in the numerator and denominator. Using Euler's recursion with renormalization evaluates continued fractions exactly while ensuring the magnitudes of intermediate values remain manageable (Blanch, G. Siam Review, Vol. 6, pages 383-421 (1964)).

Finally, and most importantly for the present application, the continued fraction representation provides a natural means of exploring several very similar rational function approximations to the same original power series. When instabilities arise in the approximations they can usually be avoided by adjusting the order of the numerator and denominator of the rational function. Using the continued fraction representation, such adjustments can be made without recomputing coefficients: lower order approximants are obtained by successive truncation of a high order continued fraction.

### APPENDICES A-C

Further details regarding methods, processes, materials, modules, components, steps, embodiments, applications, features, and advantages are set forth in the attached Appendices A-C: Appendix A, “Predicting the Molecular Complexity of Sequencing Libraries” (7 pages); Appendix B, “Predicting Molecular Complexity in High-Throughput Sequencing” (39 pages); Appendix C, “Predicting Genomic Coverage by Probabilistic Binning and Extrapolation” (2 pages). The entire content of Appendices A-C is incorporated herein in its entirety. All articles, patents, patent applications, and other publications which have been cited herein, including those cited in Appendices A-C, are incorporated herein by reference in their entirety.

Unless otherwise indicated, the sequencing and computation systems that have been discussed herein may be implemented with a computer system configured to perform the functions that have been described herein for the component. Each computer system includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

The computer system may include one or more computers at the same or different locations. When at different locations, the computers may be configured to communicate with one another through a wired and/or wireless network communication system.

The computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

1. (canceled)

2. A method of determining an expected number of member types in a data set of members, each of the member types comprising a number of the members and differing in a characteristic from all other of the member types, the method comprising:
determining, by a processor and from input of a first sample of the data set, a number of the members of each the member types in the first sample;
based on the number of members of each of the member types in the first sample, estimating an expected number of the member types that would be observed once, twice, and so forth, in a second sample of the data set, wherein the estimating is by a processor programmed to determine, by an alternating power series, the expected number of the member types;
approximating the power series by a ratio of polynomials;
determining, by a processor and based on the polynomials, and outputting, an expected number of the member types in a subset, larger than the first sample, of the data set.

3. The method of claim 2, further comprising recommending, based on the expected number of the member types in the subset, whether to obtain an additional sample from the data set.

4. The method of claim 2, wherein the number of members of each member type in the first sample comprises a frequency.

5. The method of claim 2, wherein the members comprise molecules, and the member types comprise distinct molecules.

6. The method of claim 2, further comprising obtaining the first sample.

7. The method of claim 2, further comprising obtaining the first sample by nucleotide sequencing.

8. The method of claim 2, wherein the members comprise nucleotide sequences.

9. The method of claim 2, wherein the member types comprise distinct nucleotide sequences.

10. The method of claim 2, wherein the members comprise genomic positions.

11. The method of claim 2, wherein the members comprise alleles.

12. The method of claim 2, wherein the members comprise RNA transcripts.

13. The method of claim 2, wherein the second sample is unobserved.

14. The method of claim 2, wherein the second sample is of a same size as the first sample.

15. The method of claim 2, wherein the second sample is larger than the first sample.

16. The method of claim 2, wherein the subset is several orders of magnitude larger than the first sample.

17. The method of claim 2, wherein the approximating comprises rearranging information in coefficients of the power series.

18. The method of claim 2, wherein the subset comprises the data set.

19. The method of claim 2, wherein each coefficient of the power series comprises an estimated expectation of a number of the member types.

20. The method of claim 2, wherein the power series comprises a Good-Toulmin power series.
